(19) United States
(12) Patent Application Publication
(10) Pub. No.: US 2004/0254878 A1
(43) Pub. Date: Dec. 16, 2004

(54) System and method for providing critical period protection to eligible borrowers

(75) Inventors: Peter Joseph Fitzsimmons, Fairfax, VA (US); Edward Willis Perry, Glenwood, MD (US)

Correspondence Address: MORGAN LEWIS & BOCKIUS LLP, 1111 PENNSYLVANIA AVENUE NW, WASHINGTON, DC, 20004, US

(73) Assignee: Community Reinvestment Acceptance Group, LLC

(21) Appl. No.: 10/460,314

(22) Filed: Jun. 13, 2003

(51) Int. Cl. G06F 17/60

(52) U.S. Cl. 705/38

(57) ABSTRACT

An innovative system and method for providing financial protection to predefined borrowers during critical periods. The system includes a financial product that includes multiple insurance products that provide financial protection against predefined insurable risks without additional cost to each predefined borrower. The financial product also includes a critical period protection premium that is paid by a private mortgage insurer to reduce the risks associated with possible default by the predefined borrower. The critical period protection premium is used to insure the predefined borrower against at least one predefined insurable risks that occur during critical periods. The financial product also includes a coverage time period and a benefit period. The coverage time period is defined as a period when the typical predefined borrower is most vulnerable to delinquency because of the predefined insurable risk. The coverage time period is based on financial limitations associated with providing the financial product. The system also includes at least one lender, at least one insurer, and an entity that establishes the financial product. The lender provides loans to the predefined borrowers. The insurer insures the loan against predefined insurable risks. The entity establishes the financial product and defines the insurable risks, the benefit period, and the critical period.

### FIELD OF THE INVENTION

The present invention relates to a system and method for providing financial products to low-to-moderate income mortgage borrowers and other low to moderate income borrowers who may benefit from and be provided the benefits of the financial products, and more particularly, relates to a system and method for providing financial products to eligible borrowers, without additional cost to the borrower, during predefined critical periods in accordance with the principles of the invention.

### BACKGROUND OF THE INVENTION

Many financial institutions that accept deposits and that are federally insured, such as thrifts, banks, and credit unions, are required to regularly report detailed financial information to a variety of federal and state regulatory agencies. This detailed financial information includes, for example, information on borrowers who access services provided by these financial institutions. This detailed financial information shows that barriers exist prohibiting certain types of borrowers from accessing services provided by these financial institutions. For example, certain borrowers may be prevented from obtaining loans offered by institutions because of a lack of qualifying income, credit or source of downpayment. Moreover, even with qualifying income, credit or downpayment, low-to-moderate income borrowers typically are associated with higher delinquency and default rates. This association often means that these borrowers may be denied access to services even when they qualify for those services. Nevertheless, these borrowers have financial needs that must be met, as recognized by various agencies of the Federal, State and Local governments and consumer advocacy groups.

In an effort to help overcome these problems and encourage financial institutions to offer greater access to services, the United States Congress enacted laws that require depository institutions to meet certain needs of the communities in which they operate. Financial institutions can meet these needs, for example, by funding credit enhancements for eligible borrowers and/or other community development activities. In particular, the Community Reinvestment Act of 1977, enacted by Congress, requires depository institutions to help meet the credit needs of certain low-to-moderate income borrowers. Pursuant to the Community Reinvestment Act, depository financial institutions are obligated to expand their markets through new services and products, and to provide financial services to eligible borrowers in designated census tracts within their geographic footprint or region. Despite the requirements of the Community Reinvestment Act, the needs of certain marketplaces, such as marketplaces with low-to-moderate income borrowers, are typically not fulfilled. For example, low-to-moderate income borrowers that are covered by the Community Reinvestment Act often cannot purchase homes because of the lack of qualifying income, lack of access to affordable housing products, limited housing stock, lack of a stable income, and/or the lack of funds for down payment on the loan.

Even when a low-to-moderate income borrower can afford to purchase a home, the borrower typically does not have enough funds to pay twenty percent of the sales price as a down payment. The loan-to-value ratio for the mortgage loan is therefore typically higher than a predefined threshold value, for example, eighty percent of the assessed value of the associated property. To provide mortgages with high loan-to-value ratios, lenders typically work with private mortgage insurers who insure the mortgage loan against delinquency and/or default by the borrower.

Upon obtaining the mortgage loan with a high loan-to-value ratio, the borrower pays, in addition to the mortgage loan payments, a monthly mortgage insurance premium. The lender transmits the mortgage insurance premium from the borrower to the mortgage insurer. The borrower typically pays the mortgage insurance premium until the loan-to-value ratio reaches the predefined threshold amount, for example, until the loan amount is eighty percent or less than the assessed value of the property associated with the loan. After the mortgage insurer receives the mortgage insurance premium, as a business incentive, the mortgage insurer typically transmits a portion of the mortgage insurance premium to the lender and the lender assumes a negotiated amount of the risks associated with default and/or delinquency by the buyer. As such, the mortgage insurance enables the lender to provide loans with high loan-to-value ratios to borrowers, protects the mortgage holder, and makes mortgages to low-to-moderate income borrowers attractive to secondary investors.

However, mortgage insurance premiums are a burden on low-to-moderate income borrowers and the higher payments, in turn, result in more delinquency and/or default when an unanticipated event, such as unemployment or disability, occurs. In accordance with federal and/or state regulations, the lender and the mortgage insurer are allowed to offer specific products/services to the borrower. For example, the mortgage insurer is allowed to offer only mortgage insurance to the borrower. This makes it difficult for the lender and mortgage insurer to provide innovative financial products and/or services to low-to-moderate income borrowers without additional costs to the borrower.

Lenders and other insurers have attempted to mitigate default and delinquency by providing financial protection to borrowers for certain critical periods, such as involuntary unemployment, disability, and death. For example, Fannie Mae™ Corporation has attempted to provide a solution by enabling the borrower to purchase a financial insurance that is built into the mortgage loan and that enables the borrower to skip mortgage payments for a predefined amount of time during a financial difficulty. Borrowers also are allowed to purchase a home warranty loan that covers repair or replacement of major mechanical systems on a property being purchased. This prevents the borrower from incurring an unexpected financial expense when a major mechanical system breaks down. In addition to obtaining a mortgage loan, however, borrowers must pay for the financial insurance and home warranty loan to access these services. For a low-to-moderate income borrower that barely qualifies for the mortgage loan, these additional services are typically unaffordable. Moreover, because the borrowers that select these insurance products are typically those who are most likely to file insurance claims, the prices associated with these insurance products are typically high.

Innovative financial products and structures are still needed to provide protection to eligible borrowers, especially, for low-to-moderate income borrowers and small business owners, during predefined critical periods. Moreover, what is needed is a structure that provides protection during a predefined critical period without increasing the cost to the borrower.

### SUMMARY OF THE INVENTION

The present invention relates to a system with an innovative financial product for providing financial protection to predefined borrowers during critical periods. The financial product includes multiple insurance products that provide financial protection against predefined insurable risks without additional cost to predefined borrowers. The financial product also includes a critical period protection premium. This critical period premium is not paid by the mortgage borrower. The premium is paid by the private mortgage insurer or directly by the mortgage lender. The critical period protection premium is used to insure the predefined borrowers against at least one predefined insurable risk that occurs during at least one critical period. The financial product also includes a coverage time period and a benefit period. The coverage time period is defined as a period when the typical predefined borrower is most vulnerable to delinquency because of the predefined insurable risk. The coverage time period and benefits are based on financial limitations associated with providing the financial product.

In an alternate embodiment of the inventive system, the critical period protection premium is paid by each of the predefined borrowers when a loan is obtained and the critical period protection premium is used to insure each predefined borrower against the predefined insurable risks that occur during coverage/critical periods.

The inventive system includes at least one lender, at least one private mortgage insurer, and a critical period protection insurer that establishes the financial product. The lender provides loans to the predefined borrowers. The private mortgage insurer insures the loan against predefined insurable risks. The critical period protection insurer establishes the financial product and defines the insurable risks, the benefit period, the critical periods and other provisions relating to the insurance contract.

The invention also includes a method for providing financial protection to predefined borrowers during critical periods. The method includes the steps of establishing at least one financial product that includes multiple insurance products that insures each predefined borrower without additional cost against predefined insurable risks during at least one predefined critical period; providing a loan to at least one predefined borrower, wherein the predefined borrower is offered protection during at least one critical period; transmitting a periodic loan payment from the predefined borrower to the lender; transmitting the private mortgage insurance premium from the lender to the private mortgage insurer to insure the predefined borrowers against the predefined insurable risk; transmitting the critical period protection premium from the private mortgage insurer to the critical period protection insurer; insuring the predefined borrower against the predefined insurable risks that occur during critical periods; requesting, by the borrower through a claim process, loan payments for a predefined benefit period if at least one of the predefined insurable risks occurs during the critical period; and paying, by the critical period protection insurer, benefit payments directly to the lender on behalf of the borrower.

Additional features and advantages of the invention will be set forth in the description that follows, and in part will be apparent from the description, or may be learned by practice of the invention. The objectives and advantages of the invention will be realized and attained by the system and method particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates a local area network that enables participants to fund credit enhancements for eligible borrowers and community development activities in accordance with the principles of the invention;

FIG. 2 illustrates participants on the LAN that provide financial protection to borrowers during predefined critical periods in accordance with the principles of the invention; and

FIG. 3 illustrates how data is transmitted in an embodiment of the invention.

### DESCRIPTION OF PREFERRED EMBODIMENTS

Reference will now be made in detail to the preferred embodiments of the present invention, examples of which are illustrated in the accompanying drawings. The present invention described below extends the functionality of the inventive system and method for providing a no-additional-cost financial protection to an eligible borrower during a predefined critical period in accordance with the principles of the invention to insure the borrower against certain predefined risks.

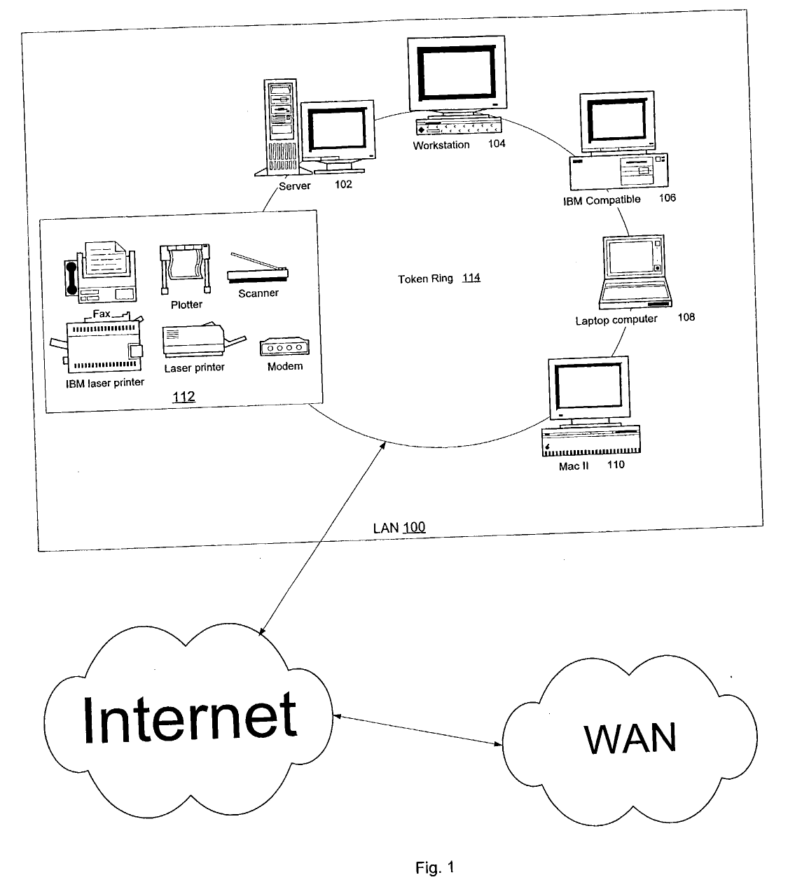

FIG. 1 illustrates a local area network (LAN) 100 that enables at least one entity to provide financial protection to borrowers during predefined critical periods. LAN 100 comprises a server 102, four computer systems 104, 106, 108 and 110, and peripherals, such as printers and other devices 112, that may be shared by components on LAN 100. Computer systems 104, 106, 108 and 110 may serve as clients for server 102 and/or as clients and/or servers for each other and/or for other components connected to LAN 100. Components on LAN 100 are preferably connected together by cable media, for example, copper or fiber-optic cable and the network topology may be a token ring topology 114. It should be apparent to those of ordinary skill in the art that other media, for example, wireless media, such as optical and radio frequency, may also connect LAN 100 components. It should also be apparent that other network topologies, such as Ethernet, may be used.

According to the invention, LAN 100 is connected to the Internet and may be connected to other LANs or Wide Area Networks (WAN). Hence some components of LAN 100 are preferably Web-enabled. The computer processors used to execute the inventive system and method, for example server 102 and/or computer systems 104, 106, 108 and 110, include electronic storage media, such as disks, for storing programming code and data structures used to implement the inventive method and outputs therefrom. The invention uses computer systems 104, 106, 108 and 110 to implement the invention described herein. Note, however, that any computer system may be configured to implement the inventive method and computer systems 104, 106, 108 and 110 are only used for exemplary purposes.

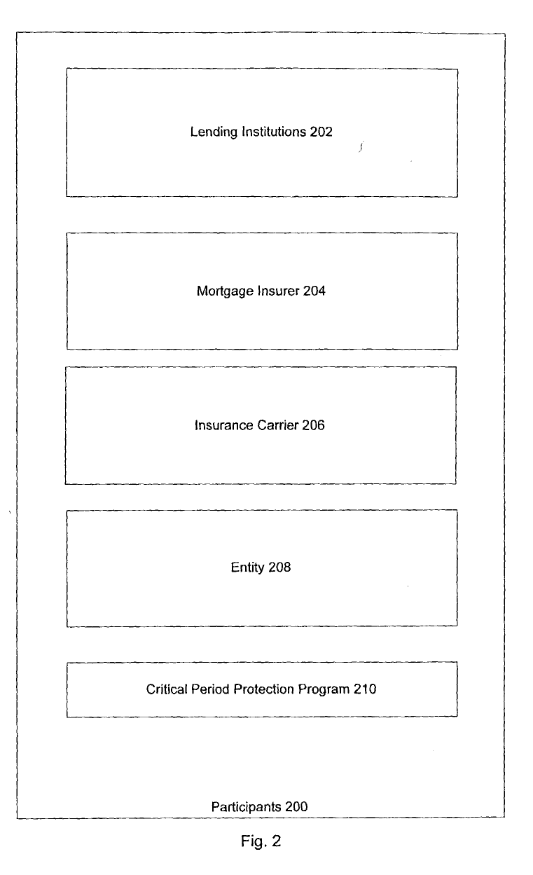

FIG. 2 illustrates participants 200 on LAN 100 that provide financial protection to borrowers during predefined coverage periods in accordance with a preferred embodiment of the invention. As shown, and discussed in more detail below, participants 200 include at least one lending institution 202, at least one private mortgage insurer 204, at least one critical period protection insurance carrier 206, and an entity 208 that structures a critical period protection program 210.

Lending institution 202 can include any type of financial institution, for example, a bank, or a credit union. Any type of lending is contemplated in accordance with the invention, including, preferably, mortgage lending. Private mortgage insurer 204 provides insurance against default and/or delinquency by a borrower. Mortgage insurer 204 preferably insures low-to-moderate income borrowers that obtain loans with high loan-to-value ratios. Critical period protection insurance carrier 206 insures the private mortgage insurer against financial loss during a predefined coverage period by repaying the borrower's loan during the predefined benefit period. Entity 208 uniquely configures existing and new insurance products into critical period protection program 210 to provide financial protection, without additional cost to the borrower, during the predefined coverage period. Critical period protection program 210 provides both direct and indirect benefits to the borrower. Specifically, critical period protection program 210 provides direct, cost-free benefits to the borrower by insuring the borrower against certain predefined risks that occur during the predefined critical coverage period. As such, critical period protection program 210 reduces risks that cause delinquency and/or default by eligible borrowers and improves the financial quality of loans to those borrowers. This makes loans to eligible borrowers more attractive to secondary market investors and may be used to increase the availability of mortgage finance in certain mortgage markets.

According to a preferred embodiment of the invention, entity 208 configures new and existing insurance products, within the parameters of established federal and state regulations, to provide a base of protection against insurable risks and to assist low-to-moderate income borrowers during predefined critical periods. Examples of insurable risks include involuntary unemployment, disability, death and/or divorce. It should be noted that the principles of this invention can be applied to any insurable event and to any group of borrowers. In an embodiment of the present invention, the duration of the critical period protection is based in part on the time period when the typical eligible borrower is most vulnerable to default and/or foreclosure because of the lack of financial assets of the eligible borrower and the predefined insurable risks. The duration of the critical period protection also is based on the financial limitations of paying for critical period protection program 210. For example, critical period protection may be provided for the first two to ten years of a mortgage loan, depending on market pricing, the history of claims by borrowers who are already enrolled in critical period protection program 210, and the private mortgage insurance still being in-force. The benefit period for each insurable risk may be based on the typical time period claimed for the risk. The benefit period may also be based on the financial resources that are available to pay for critical period protection program 210. For example, the benefit period for involuntary unemployment may be up to six months and the benefit period for disability may be up to nine months, depending on available financial resources. According to a preferred embodiment of the invention, the number of benefit payments per claim may be from three to twelve months for a mortgage loan, with a predefined maximum benefit period for each loan. It should be apparent to one skilled in the art that entity 208 may establish any reasonable benefit period. The benefit period is preferably not activated for a predefined time period, for example two months, after the insurable risk occurs.

When an eligible borrower, for example a low-to-moderate income borrower, obtains a loan from lending institution 202, the borrower is offered the opportunity to participate in a mortgage loan program that has as a component of the mortgage loan program the critical period protection program 210. In one embodiment of the present invention, the critical protection program is available to only low-to-moderate income borrowers who must pay mortgage insurance premiums because of high loan-to-value ratios. In a preferred embodiment, entity 208 automatically enrolls the borrower through an electronic list bill enrollment process. The borrower then receives at least one certificate, preferably from insurance carrier 206, identifying the carrier, contact person(s), and claims information, and specifying the amount of coverage that is available for each insurable risk.

To provide the critical period protection program 210 at no cost to the borrower, private mortgage insurer 204 does not change the private mortgage insurance rate associated with the mortgage insurance premium. When the borrower pays the monthly mortgage payment amount, lending institution 202 transmits the private mortgage insurance premium to the private mortgage insurer. The private mortgage insurer then forwards the critical period protection premium to an appropriate party to fund critical period protection program 210. The appropriate party may be critical period protection insurance carrier 204, entity 208, or an agent of entity 208. The appropriate party then transmits the critical period protection insurance premium to the critical period protection insurance carrier 206, and the critical period protection insurance carrier 206 in turn insures the borrower against risks that are defined in critical period protection program 210. In this embodiment, critical period protection program 210 protects the borrower for a predefined time. For example, the critical period protection program 210 covers the mortgage payment for six months anytime during the life of the mortgage insurance should the borrower become unemployed. In another example, the critical period protection program 210 covers the mortgage payment for six months anytime during a predefined period that is shorter than the life of the mortgage insurance should the borrower become unemployed.

The inventive critical period protection program 210 therefore enables lending institution 202 to invest in any eligible community and preferably in the low-to-moderate income community. Critical period protection program 210 also enables lending institution 202 to provide more loans to low-to-moderate income borrowers and mitigates against adverse selection that is typically associated with mortgage insurance programs.

In another embodiment of the invention, critical period protection program 210 is available to borrowers, where there is an up-front premium paid when a mortgage loan is obtained by an entity other than the mortgage borrower. In yet another embodiment, critical period protection program 210 is available to individual borrowers who agree to pay an increased mortgage interest rate when the mortgage loan is obtained. In yet still another embodiment, critical period protection program 210 is available to a group of borrowers who agree to pay an increased mortgage insurance premium when the mortgage loan is obtained. The coverage periods for these embodiments are based on the amount paid. For example, the coverage period may be for the life of the mortgage or some shorter period of time

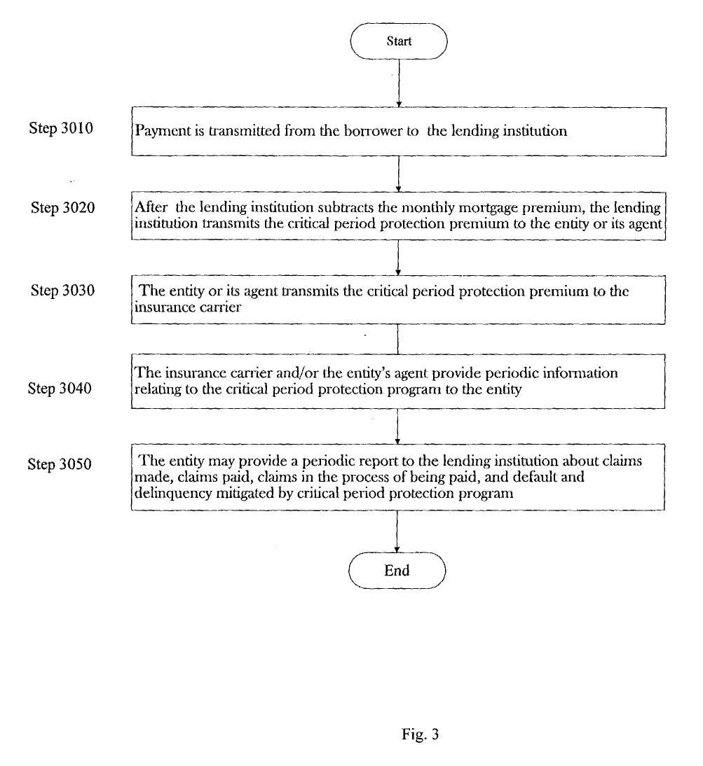

Data is transmitted in the inventive system through electronic data interface for efficiency and effectiveness of each transaction. FIG. 3 illustrates how data is transmitted in an embodiment of the invention. In Step 3010, payment is transmitted from the borrower to lending institution 202. After lending institution 202 subtracts the monthly mortgage premium, in step 3020, lending institution transmits the critical period protection premium to entity 208 or its agent. Note that mortgage insurer 204 or any third party could act as an agent for entity 208. In Step 3030, entity 208 or its agent transmits the critical period protection premium to insurance carrier 206. Insurance carrier 206 uses the critical period protection premium to insure the borrower against those risks that are defined in the critical period protection program. In Step 3040, insurance carrier 206 and/or the agent provide periodic information relating to critical period protection program 210 to entity 208. In another embodiment of the invention, lending institution 202 transmits the critical period protection premium directly to insurance carrier 206.

In Step 3050, entity 208 may provide a periodic report to lending institution 202 about claims made, claims paid, claims in the process of being paid, and default and delinquency mitigated by critical period protection program 210. Entity 208 may also provide a periodic report to lending institution 202 about events that may trigger default and/or delinquency even though a claim is not yet activated for the event. This enables lending institution 202 to mitigate to delinquency and/or default by working with the borrower until critical period protection program 210 is activated.

In order to file a claim the borrower contacts the parties identified on the insurance certificate. The borrower is then required to provide information that proves that the insurable risk occurred, the borrower is eligible for the benefit, and that the insurable event is covered. For example, the borrower may be required to provide unemployment information from the state or local government. Upon verifying that the insurable risk did occur, insurance carrier 206 processes the claim in the normal course of business and pays the benefit payments directly to lending institution 202 or an associated mortgage servicer as identified on the claim form.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A financial product for providing financial protection to predefined borrowers during at least one critical period, the financial product comprises:
a plurality of insurance products that provide financial protection against at least one predefined insurable risk without additional cost to each of the predefined borrowers, wherein a critical period protection premium that is deducted from other loan related fees is added to a loan rate that is offered to each predefined borrower and the critical period protection premium is used to insure each predefined borrower against the at least one predefined insurable risk that occurs during at least one critical period;
a predefined coverage time for protecting the predefined borrower against each predefined insurable risk; and
a benefit period that is associated with each predefined insurable risk, wherein the financial product is used to repay the loan during the benefit period when the predefined uninsurable risk occurs.

2. The financial product of claim 1, wherein the predefined coverage time is defined as a period when the typical predefined borrower is most vulnerable to delinquency because of the predefined insurable risk, and wherein the coverage time period is based on financial limitations associated with providing the financial product

3. The financial product of claim 1, wherein the predefined borrowers are low-to-moderate income borrowers.

4. The financial product of claim 1, wherein when the predefined borrower obtains a loan from at least one lender, the protection program is a component of a mortgage loan program at no additional expense to the predefined borrower.

5. The financial product of claim 1, wherein the benefit period is based on a typical time period claimed for each insurable risk by a typical predefined borrower and the limitations of the financial resources for providing the financial product.

6. The financial product of claim 1, wherein the financial product meets the requirements established by state and federal regulations.

7. The financial product of claim 1, wherein the insurable predefined risks include unemployment, disability, death, home maintenance and divorce.

8. The financial product of claim 1, wherein the benefit period is not activated for a predefined time period after the predefined insurable risk occurs.

9. The financial product of claim 1, wherein financial product is offered to borrowers who pay mortgage insurance and the critical period protection premium is paid by a private mortgage insurance carrier.

10. The financial product of claim 9, wherein the coverage period is the life of the mortgage insurance term.

11. The financial product of claim 9, wherein the coverage period is less than the life of the mortgage insurance term.

12. A financial product for providing financial protection to predefined borrowers during at least one critical period, the financial product comprises:
a plurality of insurance products that provide financial protection against at least one predefined insurable risk, wherein a critical period protection premium is paid by a mortgage insurance carrier and the critical period protection premium is used to insure each predefined borrower against the at least one predefined insurable risk that occurs during at least one critical period;
a coverage time period that is defined as a period when the typical predefined borrower is most vulnerable to delinquency because of the predefined insurable risk, wherein the coverage time period is based on financial limitations associated with providing the financial product; and
a benefit period for each predefined insurable risk, wherein the financial product is used to repay the loan during the benefit period when the predefined uninsurable risk occurs.

13. A system for providing financial protection to predefined borrowers during at least one critical period, the system comprises:
at least one lender that provides loans to the predefined borrowers;
at least one mortgage insurer for insuring the loan against default;
at least one critical period protection insurer for insuring the loan against at least one predefined insurable risk;
an entity for establishing at least one financial product that comprises a plurality of insurance products that provide financial protection against each predefined insurable risk without additional cost to each of the predefined borrowers, wherein a critical period protection premium that is deducted from other loan related fees is added to a loan rate offered to each predefined borrower by the lender and the critical period protection premium is used by the insurer to insure each of the predefined borrowers against at least one predefined insurable risk that occurs during at least one critical period; and
means for transmitting periodic critical period protection premiums from the mortgage insurer to the critical period protection insurer.

14. The system of claim 13, wherein the mortgage insurer is a private mortgage insurer.

15. The system of claim 13, wherein the financial product comprises a coverage time period that is defined as a period when the typical predefined borrower is most vulnerable to delinquency because of the predefined insurable risk, wherein the coverage time period is based on financial limitations associated with providing the financial product.

16. The system of claim 13, wherein the financial product comprises a benefit period for each predefined insurable risk, wherein the financial product is used to repay the loan during the benefit period when the predefined uninsurable risk occurs.

17. The system of claim 13, wherein the insurer provides periodic information relating to the financial product to the entity.

18. The system of claim 13, wherein the entity provides a periodic report to the lender about claims made, claims paid, claims in the process of being paid, and default and delinquency mitigated by use of the financial product.

19. The system of claim 13, wherein the entity provides a periodic report to the lender about an event that may trigger default and delinquency even though a claim is not yet activated for the event.

20. The system of claim 13, wherein data is transmitted through electronic data interface.

21. A method for providing financial protection to predefined borrowers during critical periods, the method comprising the steps of:
establishing at least one financial product that comprises a plurality of insurance products that insure each predefined borrower against at least one predefined insurable risk without additional cost during at least one predefined critical period;
providing a loan to at least one predefined borrower, wherein the predefined borrower is offered protection during at least one critical period and wherein the loan includes a critical period protection premium that is deducted from other loan related fees;
transmitting a periodic loan payment from the predefined borrower to a lender;
transmitting the critical period protection premium from the lender to an insurer to insure the predefined borrower against the predefined insurable risk;
insuring the predefined borrower against at least one predefined insurable risk that occurs during at least one critical period;
requesting, by the borrower, insured loan payments for a predefined time if at least one predefined insurable risk occurs during at least one critical period; and
paying, by the insurer, benefit payments directly to lender on behalf of the borrower.

22. The method of claim 21, wherein the step of providing further comprises the steps of:
automatically enrolling the predefined borrower through an electronic list bill enrollment process; and
providing the predefined borrower with at least one certificate that identifies an insurance carrier, a contact person, and claims information, and that specifies the amount of coverage that is available for each insurable risk.

23. The method of claim 21, wherein the step of requesting further comprises the steps of:
contacting at least one party identified on an insurance certificate; and
providing information that proves that the insurable risk occurred.

24. A computer-readable medium whose contents cause a computer system to provide financial protection to predefined borrowers during critical periods, by performing the steps of:
establishing at least one financial product that comprises a plurality of insurance products that insure each predefined borrower against predefined insurable risks without additional cost during at least one predefined critical period;
providing a loan to at least one predefined borrower, wherein the predefined borrower is offered a mortgage loan that incorporates a critical period protection during the at least one predefined critical period;
transmitting a periodic loan payment from the predefined borrower to a lender;
transmitting a mortgage insurance premium from the lender to a mortgage insurer;
transmitting the critical period protection premium from the mortgage insurer to a critical period protection insurer to insure the predefined borrowers against the predefined insurable risk;
insuring the predefined borrower against the predefined insurable risks that occur during critical periods;
requesting, by the borrower, loan payments for a predefined time if at least one of the predefined insurable risks occurs during the critical period; and
paying benefit payments directly to lender on behalf of the borrower.

25. A computer-readable medium of claim 25, wherein the mortgage insurer is a private mortgage insurer.
